(19) United States
(12) Patent Application Publication
(10) Pub. No.: US 2014/0329254 A1
(43) Pub. Date: Nov. 6, 2014

(54) BIOSENSOR USING REDOX CYCLING

(71) Applicant: PUSAN NATIONAL UNIVERSITY INDUSTRY-UNIVERSITY COOPERATION FOUNDATION, Busan (KR)

(72) Inventors: Hae Sik Yang, Busan (KR); Muhamad Rajibul Akanda, Busan (KR)

(73) Assignee: PUSAN NATIONAL UNIVERSITY INDUSTRY-UNIVERSITY COOPERATION FOUNDATION, Busan (KR)

(21) Appl. No.: 14/365,313

(22) PCT Filed: Dec. 13, 2012
(86) PCT No.: PCT/KR2012/010845

§ 371 Date: Jun. 13, 2014

(30) Foreign Application Priority Data
Dec. 16, 2011 (KR) 10-2011-0136222
Nov. 28, 2012 (KR) 10-2012-0136254

(51) Int. Cl. G01N 27/327; G01N 21/77

(52) U.S. Cl. CPC G01N 27/3271; G01N 21/77
USPC 435/7.9; 204/403.14

(57) ABSTRACT

The present invention relates to a biosensor using dual amplification of signal amplification by means of enzymes coupled with signal amplification by means of redox cycling, and to the use of a technology that maintains a slow reaction state between redox cycling materials without the use of redox enzymes, and induces quick chemical-chemical redox cycling. In addition, the present invention relates to a biosensor which obtains triple amplification by inducing electrochemical-chemical-chemical redox cycling, in addition to signal amplification by means of enzymes and signal amplification by means of chemical-chemical redox cycling.

### CROSS-REFERENCE TO RELATED APPLICATIONS

This application is a 371 National Phase of PCT/KR2012/010845, filed on Dec. 13, 2012, which claims priority to and the benefit of Korean Patent Application Nos. 10-2011-0136222 filed on Dec. 16, 2011 and 10-2012-0136254 filed on Nov. 28, 2012 in the Korean Intellectual Property Office, the entire contents of which are incorporated herein by reference in their entirety for all purposes.

### TECHNICAL FIELD

The present invention relates to a biosensor which measures the presence or concentration of a biomolecule with high sensitivity, and more particularly, to a biosensor which obtains signal amplification using redox cycling.

### BACKGROUND ART

The signal amplification essential for rapid measurement with high sensitivity is achieved by chemical amplification or physical amplification. The chemical amplification refers to amplification of a material to be measured or amplification of a material which sends out many signals per material to be measured, and the physical amplification refers to an increase in sensitivity of a signal transducer. In general, the chemical amplification may enhance the signal level without enhancing the background level, and thus provides a large signal-to-background ratio. Accordingly, it is preferred that chemical amplification, which is high, selective, and excellent in reproducibility, is used for high sensitivity detection.

In order to generally obtain high chemical amplification, single amplification (Porstmann, T.; Kiessig, S. T.; J. Immunol. Methods 1992, 150, 5-21) using a catalytic reaction, and double amplification (Stanley, C. J.; Cox, R. B.; Cardosi, M. F.; Turner, A. P. F. J. Immunol. Methods 1988, 112, 153-161. Niwa, O. Electroanalysis 1995, 7, 606-613. Limoges, B.; Marchal, D.; Mavre F.; Saveant, J. J. Am. Chem. Soc. 2008, 130, 7276-7285) simultaneously using a catalytic reaction and redox cycling are used. The catalytic reaction is usually achieved by enzyme, and the enzyme may be a biomolecule to be measured, and a label used when the biomolecule is measured. The redox cycling is classified into electrochemical-electrochemical redox cycling in which oxidation and reduction occur in two electrodes (O. Niwa, Electroanalysis 1995, 7, 606-613), and electrochemical-chemical redox cycling using one electrode and one reductant (or oxidant) (Das, J.; Jo, K.; Lee, J. W.; Yang, H. Anal. Chem. 2007, 79, 2790-2796. Akanda, M. R.; Aziz, M. A.; Jo, K.; Tamilavan, V.; Hyun, M. H.; Kim, S.; Yang, H., Anal. Chem. 2011, 83, 3926-3933, Korean Patent No. 10-0812573). As another method of redox cycling, there is enzymatic-enzymatic redox cycling using one reductant and one oxidant (Stanley, C. J.; Cox, R. B.; Cardosi, M. F.; Turner, A. P. F. J. Immunol. Methods 1988, 112, 153-161. Lovgren, U.; Kronkvist, K.; Johansson, G.; Edholm, L.-E., Anal. Chim. Acta 1994, 288, 227-235; U.S. Pat. No. 4,318,980; U.S. Pat. No. 4,446,231; U.S. Pat. No. 4,595,655). In this case, when a material necessary for redox cycling is produced by a catalytic reaction of enzyme, and the like, the redox cycling continuously occurs, in which after being oxidized (or reduced) (with the help of an enzyme) by means of an oxidant (or a reductant), the material is reduced (or oxidized) (with the help of an enzyme) by means of a reductant (or an oxidant) to go back to the original material. Through the redox cycling, amplification of a material produced by the reduction of the oxidant (or a material produced by the oxidation of the reductant) occurs, and when a signal is obtained by the material, a large signal amplification may be obtained. When the difference in standard reduction potential between the oxidant and the reductant to be used in redox cycling is large, a rapid redox cycling may be obtained, but even in the situation where there is no material which induces redox cycling, a reaction between the oxidant and the reductant occurs, and thus there is a problem in that the material produced by the reduction of the oxidant and the material produced by the oxidation of the reductant are produced abundantly. In this case, it becomes impossible to obtain a low background level. For this problem, a biosensor using enzymatic-enzymatic redox cycling uses a method of inducing oxidation by the oxidant in a situation where a reaction-selective redox enzyme is present after a very slow reaction of the reductant and the oxidant is selected, and inducing reduction by the reductant in a situation where another reaction-selective redox enzyme is present (redox cycling is obtained in a situation where at least one of two redox enzymes needed is present) (Stanley, C. J.; Cox, R. B.; Cardosi, M. F.; Turner, A. P. F. J. Immunol. Methods 1988, 112, 153-161. Lovgren, U.; Kronkvist, K.; Johansson, G.; Edholm, L.-E. Anal. Chim. Acta 1994, 288, 227-235; U.S. Pat. No. 4,318,980; U.S. Pat. No. 4,446,231; U.S. Pat. No. 4,595,655). That is, there is used a method of fairly well inducing an oxidation reaction by an oxidant and a reduction reaction by a reductant, which are thermodynamically feasible but rarely occur kinetically, kinetically by selective redox enzymes. In this case, a reaction between the oxidant and the reductant rarely occurs because a third redox enzyme, which makes the reaction between the two rapid, is not present.

In the biosensor using enzymatic-enzymatic redox cycling as described above, the reaction rate of oxidation and reduction reactions necessary for redox cycling is controlled by redox enzymes. Accordingly, there is need for the development of a signal amplification technology which may induce a rapid redox cycling more simply without using redox enzymes (in a state where the reaction between the oxidant and the reductant is slow).

Meanwhile, a material amplified by enzyme and redox cycling may be electrochemically oxidized or reduced in the electrode, thereby obtaining an electrochemical signal. However, there is a problem in that the background current is increased because a substrate used in the enzyme reaction, an oxidant and a reductant used in the oxidation and reduction, and oxygen present in the solution participate in the electrochemical reaction during the measurement of signals. In order to solve the problem, there is used a method of minimizing the electrode reaction by using an electrode which is poor in electrode catalytic properties (Das, J.; Jo, K.; Lee, J. W.; Yang, H. Anal. Chem. 2007, 79, 2790-2796).

In general, diamond electrodes or tin oxide electrodes such as ITO (indium tin oxide) are frequently used as the electrode which is poor in electrode catalytic properties. These electrodes provide a very low and reproducible background current. However, since electrode catalytic properties of these electrodes are not good, there is a problem in that the amplified signal material is not easily electrochemically oxidized (or reduced). In order to enhance electrode catalytic properties a little, a method of modifying the electrode surface with a material which is excellent in electrode catalytic properties (a metal catalyst or an electron transfer mediator) is being used.

Since it requires an additional work to apply a material, which is excellent in electrode catalytic properties, to an electrode which is poor in electrode catalytic properties, there is need for the development of a simple biosensor which need not use an electrode applied with the material which is excellent in electrode catalytic properties.

In a biosensor for POCT (point of care testing), all the measurement procedures need to be automatically performed after a sample is dropped onto the biosensor. It is necessary to perform measurement using only a sample without additionally using another solution except for the sample, in order to simply perform the fluid control, such as washing needed during the measurement procedure. Since there are many interferents, which are electrochemically active, such as ascorbic acid, in a sample such as whole blood or serum, a large signal-to-background ratio may not be obtained in a general biosensor which electrochemically measures a product produced by enzyme. There is need for the development of a technology which amplifies the electrochemical signal of a product while minimizing the electrochemical signal of an interferent which is electrochemically active.

### SUMMARY OF THE INVENTION

The present invention has been made in an effort to provide a technology that maintains a slow reaction state between an oxidant and a reductant without the use of redox enzymes for redox cycling, and induces quick chemical-chemical redox cycling in a biosensor using dual amplification of signal amplification by means of enzymes coupled with signal amplification by means of redox cycling.

The present invention has been made in an effort to provide a biosensor which obtains triple amplification by electrochemically inducing another redox cycling (electrochemical-chemical-chemical redox cycling) in addition to signal amplification by means of an enzyme label and signal amplification by means of chemical-chemical redox cycling.

The present invention has been made in an effort to provide a technology which makes the desired electron transfer types of materials participating in the amplification different from each other in order to obtain a large signal-to-background ratio when the double amplification and the triple amplification are used.

The present invention has been made in an effort to provide characteristics of an enzyme and an electrode to be used in the double amplification and the triple amplification. Specifically, the present invention has been made in an effort to provide characteristics of an enzyme which is not affected by an oxidant and a reductant, and characteristics of an electrode which uses the poor state of electrode catalytic properties as it is without any need for applying a material which is excellent electrode catalytic properties to the electrode.

The present invention has been made in an effort to provide a technology of obtaining a large signal-to-background ratio by inducing an electrochemical-chemical-chemical redox cycling in which an interferent participates to occur slowly, and an electrochemical-chemical-chemical redox cycling, in which a product sending out a signal participates, to occur rapidly in a situation where the electrochemical signal of the interferent is not significant by using an electrode which is poor in electrode catalytic properties during the measurement of an electrochemical signal.

The objects and various advantages of the present invention will be clearer by the subsequent explanation with reference to the accompanying drawings by those skilled in the art.

The reaction rate of the redox reaction depends on a material participating in the reaction and the type of electron transfer. It is known that the electron transfer between inorganic coordination complexes is achieved through the inner-sphere electron transfer or the outer-sphere electron transfer (Taube, H. Angew., Chem. Int. Ed. 1984, 23, 329-339). Further, it is known that the electron transfer between organic materials may also be explained using the inner-sphere electron transfer and the outer-sphere electron transfer (Rosokha, S. V.; Kochi, J. K. Acc. Chem. Res. 2008, 41, 641-653). When an electron transfer occurs in a situation where the degree of electron coupling or orbital overlap between two materials in which the electron transfer occurs is very small, the electron transfer may refer to an outer-sphere electron transfer, and when an electron transfer occurs in a situation where the degree thereof is very large, the electron transfer may refer to an inner-sphere electron transfer. Even in an electrode reaction, when an electron transfer occurs through a weak electron connection of a material to be oxidized (or reduced) to the electrode, the electron transfer may refer to an outer-sphere electron transfer, and when an electron transfer occurs through a strong electron connection thereof, the electron transfer may refer to an inner-sphere electron transfer. When a material in which redox occurs by means of the outer-sphere electron transfer is defined as an “outer-sphere electron transfer material” which favors the outer-sphere electron transfer, and a material in which redox occurs by means of the inner-sphere electron transfer is defined as an “inner-sphere electron transfer material” which favors the inner-sphere electron transfer, the electron transfer in a strong outer-sphere electron transfer material usually occurs only by means of the outer-sphere electron transfer, and the electron transfer in a strong inner-sphere electron transfer material usually occurs only by means of the inner-sphere electron transfer. Accordingly, the electron transfer between the strong outer-sphere electron transfer material and the strong inner-sphere electron material rarely occurs. Many redox reactions of organic compounds may occur by means of the inner-sphere electron transfer and the outer-sphere electron transfer. These materials are reacted with the strong inner-sphere electron transfer material, and also reacted with the strong outer-sphere electron transfer material.

Accordingly, the present invention is characterized in that a strong outer-sphere electron transfer material and a strong inner-sphere electron transfer material are each used as an oxidant (or a reductant) or a reductant (or an oxidant), that is, the electron transfer type of redox reaction of the oxidant and the reductant is selected to be different from each other, and a material, in which the outer-sphere electron transfer as well as the inner-sphere electron transfer occurs well, is used as a mediating material, which induces redox cycling, thereby inducing a rapid redox cycling by means of a rapid redox reaction among the oxidant, the reductant, and the mediating material, while maintaining a slow reaction state of the redox reaction between the oxidant and the reductant without using a redox enzyme. In the present invention, it is possible to obtain large signal amplification through double amplification (signal amplification by means of an enzyme label and signal amplification by means of chemical-chemical redox cycling) by the rapid redox cycling.

For this purpose, the present invention provides a biosensor which measures the presence and concentration of a biomolecule, the biosensor including: an enzyme which activates a substrate; a substrate which is activated by the enzyme and becomes a product to be subjected to a redox reaction; and a reductant and an oxidant which achieve the redox cycling by means of the redox reaction of the product, in which a direct redox reaction between the oxidant and the reductant kinetically rarely occurs by varying an electron transfer type of the oxidant and the reductant in the redox reaction, the electron transfer types of both the oxidant and the reductant in the redox reaction are the same as each other in the product, and the redox reaction and the redox cycling of the oxidant and the reductant are achieved by mediation of the product, and a signal is sensed from an electrochemical, color, or fluorescent change of an oxidation product of the reductant or a reduction product of the oxidant, which is amplified and produced by means of repetition of the redox cycling.

FIG. 1 is a concept view of dual amplification using amplification by means of an enzyme and amplification by means of chemical-chemical redox cycling, which are presented by the present invention. The enzyme may be a biomolecule to be detected, and a label to be used in the detection of a biomolecule. First of all, a substrate 12 is turned into a product 13 by means of an enzyme 11. When the enzyme is a biomolecule to be detected and is used as a label, the product 13 is selectively formed only by means of a reaction of the enzyme. The product 13 thus formed is reacted with an oxidant (or a reductant) 15, and then becomes an oxidized product (or a reduced product) 14, and the oxidized product (or the reduced product) 14 is reacted with a reductant (or an oxidant) 17 to become the product 13 again. Through repetitive occurrence of the redox cycling, many oxidants (or reductants) 15 are turned into a reduced material of the oxidant (or an oxidized material of the reductant) 16, and many reductants (or oxidants) 17 are turned into an oxidized material of the reductant (or a reduced material of the oxidant) 18. Since the reduced material of the oxidant (or an oxidized material of the reductant) 16 or the oxidized material of the reductant (or a reduced material of the oxidant) 18 may be prepared in a large amount per enzyme 11, a large amplification of a material may be obtained. The reduced material of the oxidant (or the oxidized material of the reductant) by means of the oxidant (or the reductant) 15 or the oxidized material of the reductant (or the reduced material of the oxidant) by means of the reductant (or the oxidant) 17 are measured by using changes in electrochemical activity, absorbance, or fluorescence intensity. The signal thus obtained is used in a biosensor which measures the concentration of a biomarker.

FIG. 2 is a concept view illustrating how an enzyme label is used in a biosensor which measures the concentration of a biomarker by using a bio-specific bond. An antibody or biomolecule 22, which forms a bio-specific bond with a biomarker 23, is immobilized on a solid surface 21, and the biomarker 23 is bound thereto. An antibody or biomolecule 24, which forms a bio-specific bond with the biomarker 23, is once again adhered to the biomarker 23. The enzyme 11 is adhered to the antibody or biomolecule 24 as a label. Only when the biomarker 23 is present on the surface, the antibody or biomolecule 24 to which the label is adhered is bound thereto, and the adhesion amount of the antibody or biomolecule 24 to which the label is adhered varies depending on the amount of the biomarker 23 in the sample. Accordingly, as the amount of enzyme 11 present on the surface varies, the amount of product produced by the enzyme reaction also varies. It is possible to indirectly know the amount of biomarker 23 by measuring the amount of product. The present invention may be applied to a biosensor in a sandwich form as described above.

The present invention may be applied even to a biosensor using a competitive reaction, a displacement reaction, and the like. A biomarker 25 and a biomarker 26 to which the enzyme 11 is adhered as a label are bound to the antibody or biomolecule 22, which forms a bio-specific bond through the competitive or displacement reaction. A higher amount of the enzyme 11 present on the surface means that the biomarker 25 is present in a less amount. Accordingly, the larger the amount of biomarker 25 is, the smaller the amount of product produced by an enzyme reaction is. The amount of biomarker 25 may be measured through such a principle. The biomarkers 23 and 25 may be DNA, RNA, protein, an organic material, and the like.

FIG. 3 is a concept view illustrating a condition for obtaining an effective redox cycling. In order to induce redox cycling only when the product 13 is produced by the enzyme 11, the reaction of the oxidant (or the reductant) 15 and the reductant (or the oxidant) 17 needs to be very slow as illustrated in FIG. 3. However, since the reaction of the oxidant (or the reductant) 15 or the reductant (or the oxidant) 17 is thermodynamically favored, the reaction needs to occur kinetically slowly. For this purpose, the present invention is characterized by using a method of making the electron transfer type occurring fairly well during the redox reaction of the oxidant (or the reductant) 15 and the electron transfer type occurring fairly well during the redox reaction of the reductant (or the oxidant) 17 different from each other. That is, when a material, in which the redox reaction usually proceeds through the inner-sphere electron transfer, is selected as the oxidant (or the reductant) 15, a material, in which the redox reaction usually proceeds through the outer-sphere electron transfer, is selected as the reductant (or an oxidant) 17. On the contrary, when a material, in which the redox reaction usually proceeds through the outer-sphere electron transfer, is selected as the oxidant (or the reductant) 15, a material, in which the redox reaction usually proceeds through the inner-sphere electron transfer, is selected as the reductant (or an oxidant) 17. In a sensor of the present invention, it is possible to make a direct redox reaction between the oxidant and the reductant occur slowly by selecting different electron transfer types for a redox reaction in each of the oxidant and the reductant as described above.

FIGS. 4 and 5 illustrate an electron transfer type which two redox reactions occurring during the redox cycling need to have. As illustrated in FIG. 4, when an electron transfer between the oxidant (or the reductant) 15 and the product 13 is close to the inner-sphere electron transfer, an electron transfer between the reductant (or the oxidant) 17 and the oxidized product (or the reduced product) 14 needs to be close to the outer-sphere electron transfer. Further, as illustrated in FIG. 5, when an electron transfer between the oxidant (or the reductant) 15 and the product 13 is close to the outer-sphere electron transfer, an electron transfer between the reductant (or the oxidant) 17 and the oxidized product (or the reduced product) 14 needs to be close to the inner-sphere electron transfer.

That is, in the present invention, in order to allow an oxidant and a reductant, which do not experience a redox reaction kinetically directly with each other, to be subjected to redox reaction rapidly without using a redox enzyme and to form a redox cycling from this as described above, a product, which may experience a rapid redox reaction with both the oxidant and the reductant, is selected and used as the product 13. In order to achieve a rapid outer-sphere electron transfer reaction and a rapid inner-sphere electron transfer reaction simultaneously, the product 13 and the oxidized product (or the reduced product) 14 need to be a material which may participate in not only the outer-sphere electron transfer reaction, but also the inner-sphere electron transfer reaction. Examples of a material in which the reaction occurs fairly well through the outer-sphere electron transfer include coordination compounds such as Ru(NH₃)₆³⁺, Ru(NH₃)₆²⁺, ferrocenium ion, ferrocene, Fe(CN)₆³⁻, Fe(CN)₆⁴⁻, Ru(NH₃)₅(pyridine)³⁺ and derivatives thereof, Ru(NH₃)₅(pyridine)²⁺ and derivatives thereof, Ru(NH₃)₄(diimine)³⁺ derivatives including Ru(NH₃)₄(bipyridyl)³⁺, and Ru(NH₃)₄(diimine)²⁺ derivatives including Ru(NH₃)₄(bipyridyl)²⁺, and examples of a material in which the reaction occurs fairly well through the inner-sphere electron transfer include a reductant such as phosphine derivatives including tris(2-carboxyethyl)phosphine, hydrazine and derivatives thereof, a reductant such as derivatives including nicotineamide adenine dinucleotide (NADH) in the nicotine amide reduced form, and an oxidant such as H₂O₂, and O₂.

Examples of a material in which the electron transfer reaction occurs fairly well as not only the outer-sphere electron transfer reaction, but also the inner-sphere electron transfer reaction include a reduced form such as hydroquinone, aminophenol and didminobenzene, which have two or more alcohol or amine functional groups (or one or more alcohol functional groups or one or more amine functional groups) in a substrate 27 having a benzene ring as illustrated in FIG. 6, and an oxidized form such as benzoquinone and quinone imine, which are an oxidized state thereof. Furthermore, derivatives thereof may also play the same role. Further, examples thereof include a reduced form such as dihydroxynaphthalene, aminonaphthol, and diaminonaphthalene, which have two or more alcohol or amine functional groups (or one or more alcohol functional groups or one or more amine functional groups) in a substrate 28 having a naphthalene ring as illustrated in FIG. 7, and an oxidized form such as naphthoquinone and naphthoquinone imine, which are an oxidized state thereof. In particular, the two reduced and oxidized forms of hydroquinone and benzoquinone and the two reduced and oxidized forms of aminophenol and quinone imine may participate in rapid outer and inner electron transfer reactions, and are relatively stably present in an aqueous solution, thereby inducing stable redox cycling.

In a situation where dual amplification is to be obtained through amplification of a signal by means of an enzyme and amplification of a signal by means of redox cycling, an enzyme, which is not greatly affected by an oxidant, a reductant, and oxygen, is used because the enzyme need not be affected by the oxidant, the reductant, and oxygen. As an enzyme which satisfies the requirements as described above, a phosphatase such as alkaline phosphatase, galactosidase, and a protease such as tripsin and thrombin may be used. The substrate 12 which is not easy in oxidation (or reduction) may be turned into the product 13 which is easy in oxidation (or reduction) by means of an enzyme reaction of phosphatase.

In the present invention, a material which is not affected by redox cycling is used as the enzyme, and a material which almost rarely participates in the redox cycling is used as the substrate. Further, as a product produced from the substrate by means of the enzyme reaction, a material which participates fairly well in redox cycling is used.

FIG. 8 is a concept view of an enzyme reaction suitable for a chemical-chemical redox cycling. Since the product 13 participates in redox cycling, but the substrate 12 does not participate in redox cycling, the substrate 12 need not be easily oxidized (or reduced) by the oxidant (or the reductant) 15, and need not be easily reduced (or oxidized) by the reductant (or the oxidizer) 16. For this purpose, as illustrated in FIG. 8, as the substrate 12, a material, which is present in a form 13 in which redox rarely occurs, and then turned into the product 13 in which redox occurs fairly well by means of an enzyme reaction, is used. Herein, as the enzyme 11, a material, which is not affected by the oxidant (or the reductant) 15 and the reductant (or the oxidant) 17, is used. For example, there is a material in which the product 13 is produced in which the redox occurs fairly well as a part of a substrate 32 is separated by the enzyme reaction as illustrated in FIG. 9. More specifically, there are a material in which a substrate 33 to which phosphate is adhered becomes a product 34 from which phosphate is separated by the enzyme 11 such as phosphatase as in FIG. 10, a material in which a substrate 35 to which galactose is adhered becomes a product 34 from which galactose is separated by the enzyme 11 such as galactosidase as in FIG. 11, a material in which a substrate 36 to which two phosphates are adhered becomes a product 37 from which phosphate is separated by the enzyme 11 such as phosphatase as in FIG. 12, a material in which a substrate 38 to which two galactoses are adhered becomes a product 37 from which galactose is separated by the enzyme 11 such as galactosidase as in FIG. 13, and the like. Further, there are a material in which a substrate 41 to which oligopeptide is adhered becomes a product 42 from which oligopeptide is separated by the enzyme 11 such as protease as in FIG. 14, a material in which a substrate 43 to which two oligopeptides are adhered becomes a product 44 from which oligopeptide is separated by the enzyme 11 such as protease as in FIG. 15, and the like. Aminophenyl phosphate, hydroquinone phosphate, aminonaphthyl phosphate, and naphthohydroquinone phosphate, which are the substrate 33 to which phosphate is adhered, and hydroquinone diphosphate and naphthohydroquinone diphosphate, which are the substrate 36 to which two phosphates are adhered, may produce aminophenol, hydroquinone, aminonaphthol, and naphthohydroquinone, which may participate in rapid outer and inner electron transfer reactions as described above, and thus are particularly favored. Aminophenyl galactose, hydroquinone galactose, aminonaphthyl galactose, and naphthohydroquinone galactose, which are the substrate 33 to which galactose is adhered, and hydroquinone digalactose and naphthohydroquinone digalactose, which are the substrate 38 to which two galactoses are adhered, may produce aminophenol, hydroquinone, aminonaphthol, and naphthohydroquinone, which may participate in rapid outer and inner electron transfer reactions as described above, and thus are particularly favored. Aminophenyl oligopeptide and aminonaphthyl oligopeptide, which are the substrate 42 to which oligopeptide is adhered, and diaminobenzene dioligopeptide and diaminonaphthalene dioligopeptide, which are the substrate 43 to which the two oligopeptides are adhered, may produce aminophenol, diaminobenzene, aminonaphthol, and diaminonaphthalene, which may participate in rapid outer and inner electron transfer reactions as described above, and thus are particularly favored.

When the dual amplification of FIG. 1 proceeds for a certain period of time, a reduced material of the oxidant (or an oxidized material of the reductant) 16 or an oxidized material of the reductant (or a reduced material of the oxidant) 18 are produced in a large amount, and when one of the two materials 16 and 18 is electrochemically oxidized or reduced, a large electrochemical signal may be obtained. Since another form of redox cycling occurs during the electrochemical measurement, triple amplification (amplification by means of an enzyme label, amplification by means of chemical-chemical redox cycling, and amplification by means of electrochemical-chemical-chemical redox cycling) may be resultantly obtained, thereby obtaining a very large signal amplification.

FIG. 16 is a concept view of electrochemical-chemical-chemical redox cycling occurring during the electrochemical measurement when the triple amplification is used. As illustrated in FIGS. 16 and 17, the reduced material of the oxidant (or the oxidized material of the reductant) 16 produced by redox cycling is oxidized (or reduced) in an electrode 51 to lose (or obtain) an electron 52. The material is electrochemically oxidized (or reduced) to go back to the oxidant (or the reductant) 15 as described above, and then is again reacted with the product 13 to become a reduced material of the oxidant (or an oxidized material of the reductant) 16. The material is again oxidized or reduced in the electrode 51 to induce another form of electrochemical-chemical-chemical redox cycling, and through the redox cycling, a higher current may be obtained. When the product 13 is in a reduced form, oxidation occurs in the electrode 51 as illustrated in FIG. 16, and when the product 13 is in an oxidized form, reduction occurs in the electrode 51 as illustrated in FIG. 17. Since the reductant (or the oxidant) 17 may be easily oxidized (or reduced) thermodynamically in the electrode 51, the reaction need not occur fairly well kinetically in the electrode 51. For this purpose, an electron transfer form occurring fairly well when the reduced material of the oxidant (or the oxidized material of the reductant) 16 is subjected to redox reaction in the electrode 51, and an electron transfer form occurring fairly well when the reductant (or the oxidant) 17 is subjected to redox reaction in the electrode 51 need to be different from each other. In particular, the reaction in the electrode 51 needs to proceed usually through the outer-sphere electron transfer, and the reaction of the reductant (or the oxidant) 17 needs to proceed usually through the inner-sphere electron transfer. Accordingly, the present invention is characterized in that in the electrode 51, the electrochemical redox reaction of the reduced material of the oxidant (or the oxidized material of the reductant) 16 occurs, and the electrochemical redox reaction of the reductant (or the oxidant) 17 rarely occurs.

As illustrated in FIGS. 18 and 19, the oxidized material of the reductant (or the reduced material of the oxidant) 18 produced by redox cycling is reduced (or oxidized) in the electrode 51 to obtain (or lose) the electron 52. As described above, the material is electrochemically reduced (or oxidized) to become the reductant (or the oxidant) 17, and then is again reacted with the oxidized product (or the reduced product) 14 to become the oxidized material of the reductant (or a reduced material of the oxidant) 18. The material is again reduced (or oxidized) in the electrode 51 to induce another form of redox cycling, and through the redox cycling, a higher current may be obtained. When the product 13 is in an oxidized form, oxidation occurs in the electrode 51 as illustrated in FIG. 18, and when the product 13 is in a reduced form, reduction occurs in the electrode 51 as illustrated in FIG. 19. Since the oxidant (or the reductant) 15 may be easily reduced (or oxidized) thermodynamically in the electrode 51, the reaction need not occur fairly well kinetically in the electrode 51. For this purpose, an electron transfer form occurring fairly well when the oxidized material of the reductant (or the reduced material of the oxidant) 18 is subjected to redox reaction, and an electron transfer form occurring fairly well when the oxidant (or the reductant) 15 is subjected to redox reaction need to be different from each other. In particular, the reaction in the electrode 51 needs to proceed usually through the outer-sphere electron transfer, and the reaction of the oxidant (or the reductant) 15 needs to proceed usually through the inner-sphere electron transfer.

In FIG. 20, each reaction participating in electrochemical-chemical-chemical redox cycling occurs so rapidly that a rapid redox cycling occurs, but in a redox cycling in which an interferent 19 participates, one of the two reactions occurs slowly, thereby making a redox cycling for the interferent 19 occur slowly. Through this, an increase in background by means of the interferent 19 may be minimized. Further, a direct electrochemical reaction of the interferent 19 to the electrode 51 may be minimized by using an electrode which is poor in electrode catalytic properties, thereby minimizing an increase in background by means of the interferent 19.

The outer-sphere electron transfer occurs fairly well in the electrode 51, but an electrode which is poor in electrode catalytic properties needs to be used in order not to induce the inner-sphere electron transfer fairly well. For this purpose, it is possible to use a tin oxide electrode including an ITO electrode and an FTO (fluorinated tin oxide) electrode, a boron-doped diamond electrode, a diamond electrode including a diamond-like carbon electrode, and the like.

Since a strong outer-sphere electron transfer material such as Ru(NH₃)₆³⁺ and Ru(NH₃)₆²⁺ has a very high electron transfer rate regardless of the electrode, a large electrochemical signal may be obtained even in an electrode which is poor in electrode catalytic properties and favors the outer-sphere electron transfer.

Since the product 13 or the oxidized product (or a reduced product) 14 in which redox may occur through the outer-sphere electron transfer or the inner-sphere electron transfer may not induce redox fairly well in an electrode which is poor in electrode catalytic properties, it is difficult to obtain a large electrochemical signal of the product 13 or the oxidized product (or the reduced product) 14 without applying a very high or very low electric potential. In FIGS. 16 and 17, redox occurs with the help of the oxidant (or a reductant) 15, and in FIGS. 18 and 19, redox occurs with the help of the reductant (or an oxidant) 17, and thus redox of the product 13 or the oxidized product (or the reduced product) 14 may be easily obtained at an electric potential close to 0 V compared to an Ag/AgCl reference electrode. Accordingly, it is not necessary to apply a material, which is excellent in electrode catalytic properties, to an electrode.

However, in the present invention, an effect of triple amplification may be obtained by using a product of a substrate which induces an electrochemical redox reaction even in an electrode which is poor in electrode catalytic properties, or an oxidized material or reduced material thereof.

FIG. 21 is a concept view of electrochemical-chemical redox cycling which may occur during the triple amplification. That is, an electrochemical-chemical-chemical redox cycling as illustrated in FIG. 16 may occur during the electrochemical measurement, and an electrochemical-chemical redox cycling (generally known) as illustrated in FIG. 21 may occur. A larger amplification of a signal may be obtained by this. FIG. 21 illustrates that the product 13 is directly oxidized in the electrode 51, and FIG. 22 illustrates that the product 13 is directly reduced in the electrode 51. Furthermore, FIG. 23 illustrates that the reduced product 14 is directly oxidized in the electrode 51, and FIG. 24 illustrates that the reduced product 14 is directly reduced in the electrode 51.

However, when an electrode which is poor in electrode catalytic properties is used, the redox reaction of the product 13 or the reduced product 14 may occur slowly in the electrode, and in this case, an electrochemical signal by means of redox cycling of the product 13 or the reduced product 14 is shown in a smaller size than an electrochemical signal by means of redox cycling of the reduced material 16 of the oxidant or the oxidized material 18 of the reductant, which is illustrated in FIG. 16.

In a biosensor according to the present invention, a large signal-to-background ratio is obtained in a short measurement time by adding only an oxidant and a reductant to induce dual amplification without additionally using an enzyme in the existing biosensor using an enzyme. Through this, a very low detection limit may be obtained.

In particular, triple amplification may be obtained by adding an electrochemical-chemical-chemical redox cycling during the electrochemical measurement, thereby enabling detection with ultrahigh sensitivity. Further, it becomes possible to use an electrode which is poor in electrode catalytic properties without any need for treatment with a material which is excellent in electrode catalytic properties. Accordingly, it becomes possible to develop a biosensor which is inexpensive, simple, and highly sensitive.

Therefore, the present invention may be utilized as a core technology of an immunoassay which analyzes an antigen or an antibody, a DNA sensor which analyzes DNA, a biosensor which analyzes the concentration of enzyme, and the like.

### BRIEF DESCRIPTION OF THE DRAWINGS

FIG. 1 is a concept view of dual amplification using amplification by means of an enzyme and amplification by means of chemical-chemical redox cycling, which are presented by the present invention.

FIG. 2 is a concept view illustrating how an enzyme label is used in a biosensor which measures the concentration of a biomarker by using a bio-specific bond.

FIG. 3 is a concept view illustrating a condition for obtaining an effective redox cycling.

FIG. 8 is a concept view of an enzyme reaction suitable for a chemical-chemical redox cycling.

FIG. 16 is a concept view of electrochemical-chemical-chemical redox cycling occurring during the electrochemical measurement when the triple amplification is used.

FIG. 21 is a concept view of electrochemical-chemical redox cycling which may occur during the triple amplification.

FIG. 25 is a concept view of an electrochemical biosensor in a sandwich form, which detects troponin I by using aminophenyl phosphate as a substrate.

FIG. 26 is a chronoamperogram obtained at an electric potential, in which oxidation of Ru(NH₃)₆²⁺ occurs with or without aminophenol in a solution containing Ru(NH₃)₆³⁺ and tris(2-carboxyethyl)phosphine.

FIG. 27 is a chronocoulogram obtained immediately after and 10 minutes after a solution is mixed.

FIG. 28 is a chronocoulogram according to the concentration of troponin I, which is obtained by the biosensor of FIG. 25.

FIG. 29 is a graph of a corrected electric charge according to the concentration of troponin I at 100 seconds in the chronocoulogram of FIG. 28.

FIG. 30 is a concept view of an electrochemical biosensor in a sandwich form, which detects a mouse antibody by using hydroquinone diphosphate as a substrate.

FIG. 31 is a graph of a corrected electric charge according to the concentration of the mouse antibody obtained at 100 seconds in the chronocoulogram for the biosensor of FIG. 30.

FIG. 32 is a concept view of an electrochemical biosensor in a sandwich form, which detects a mouse antibody by using aminonaphthyl galactose as a substrate.

FIG. 33 is a chronocoulogram of the background and the signal with or without an ascorbic acid interferent.

FIG. 34 is a graph of a corrected electric charge according to the concentration of the mouse antibody obtained at 100 seconds in the chronocoulogram for the biosensor of FIG. 32.

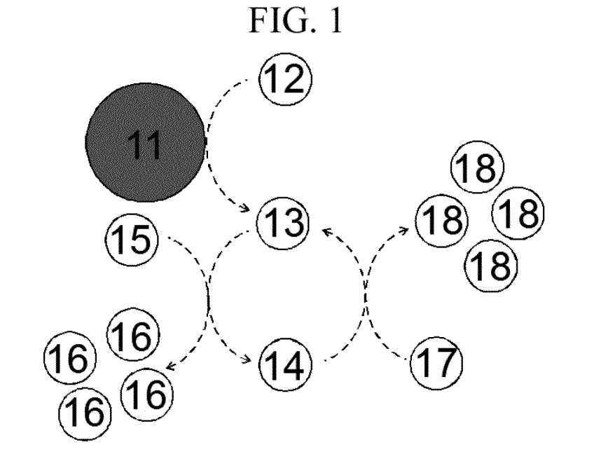

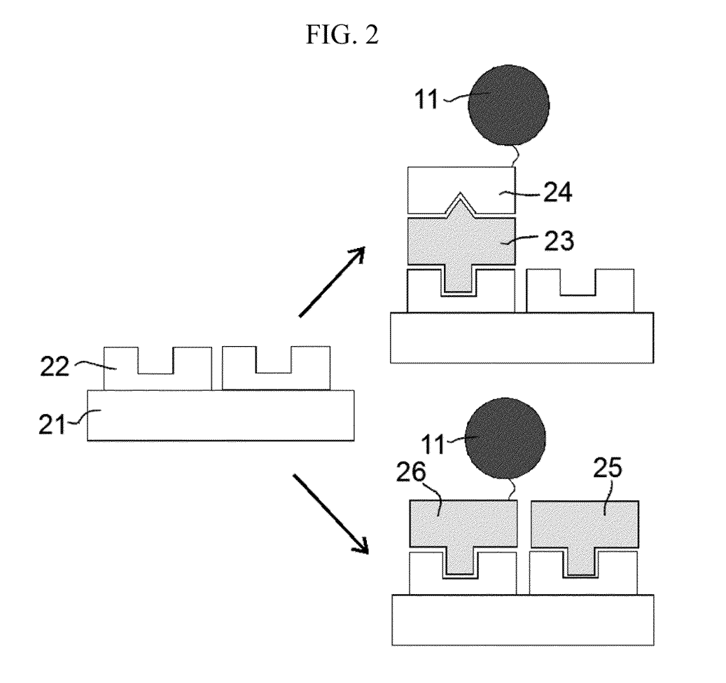

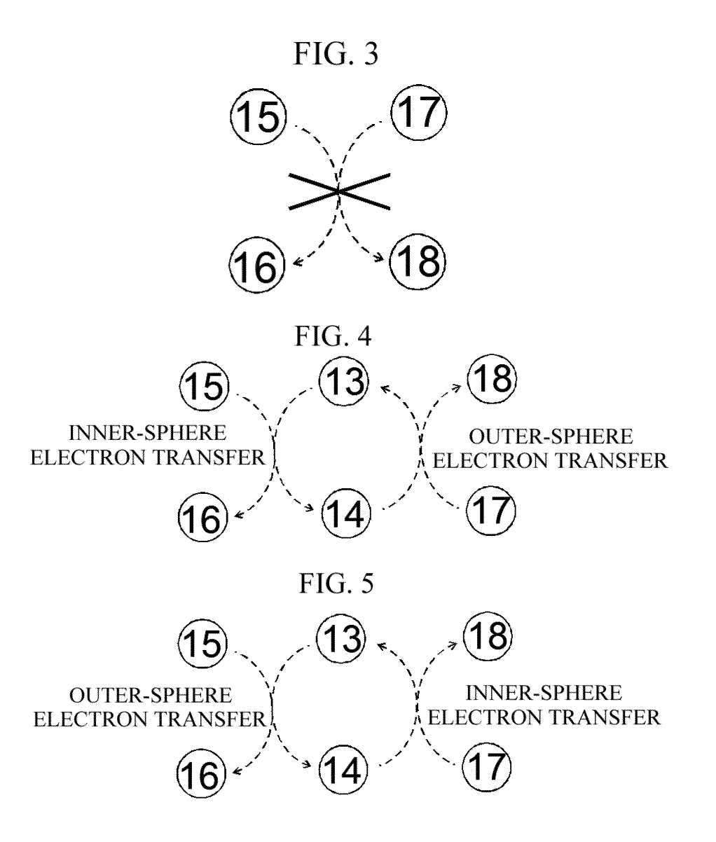

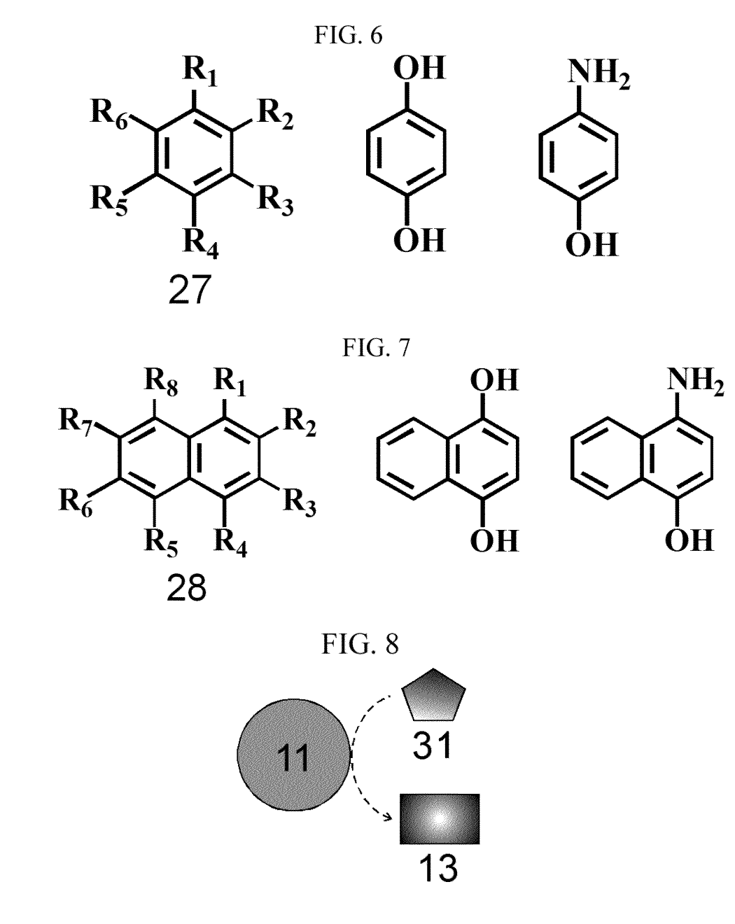

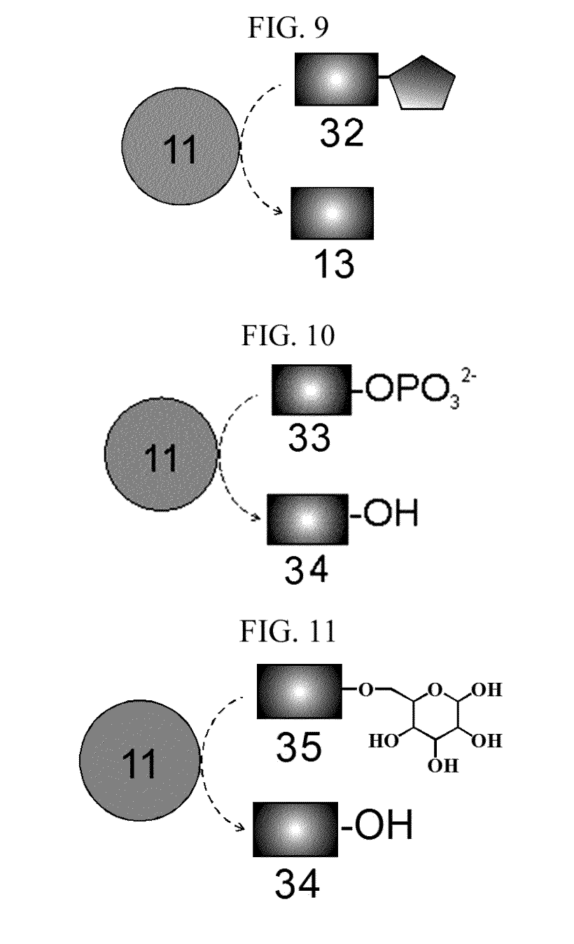

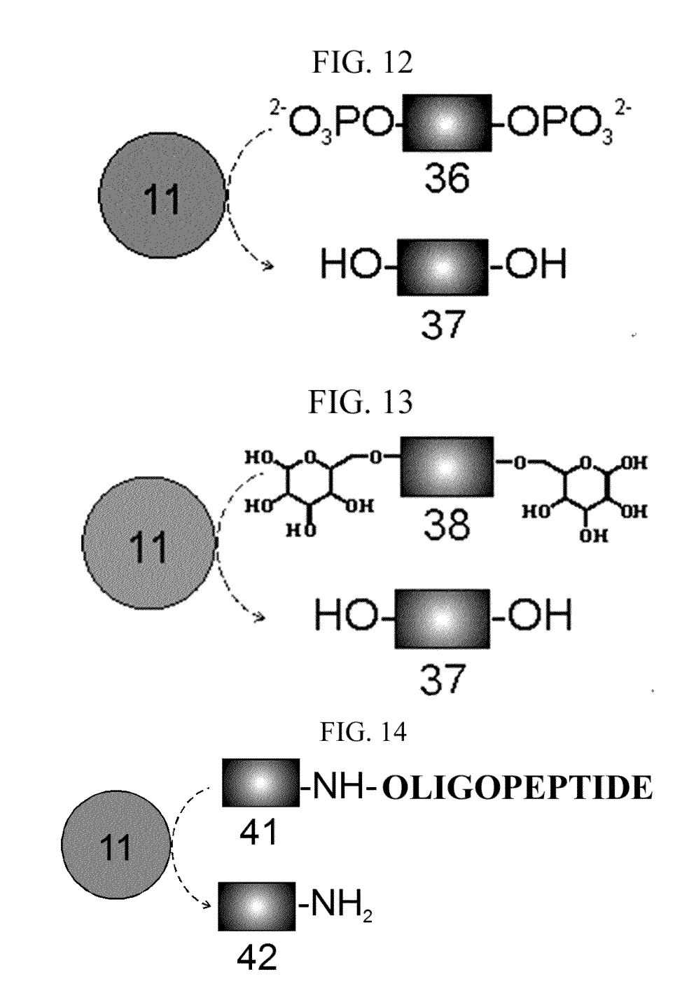

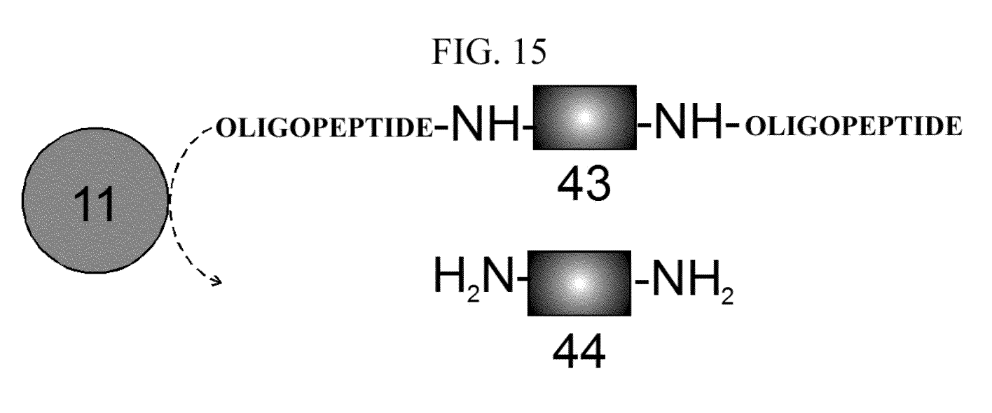

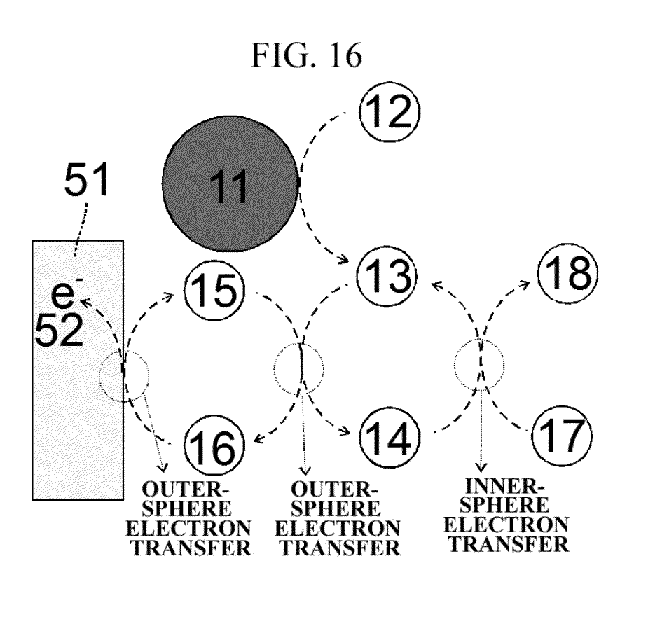

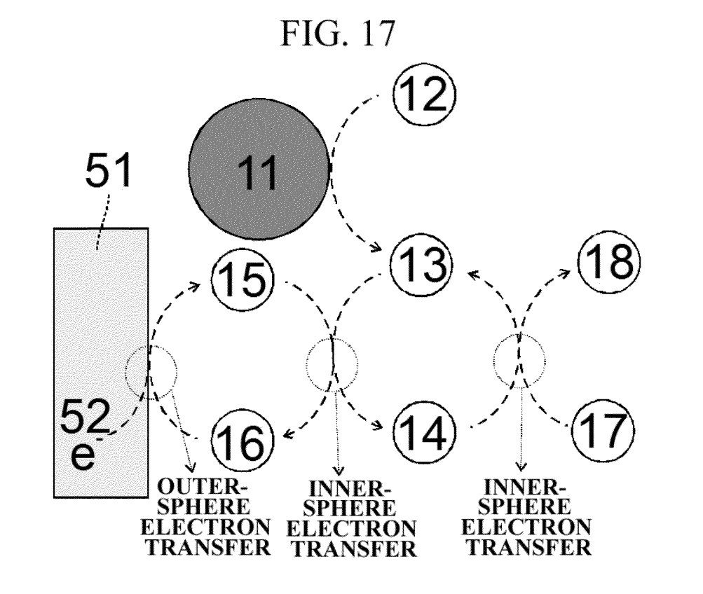

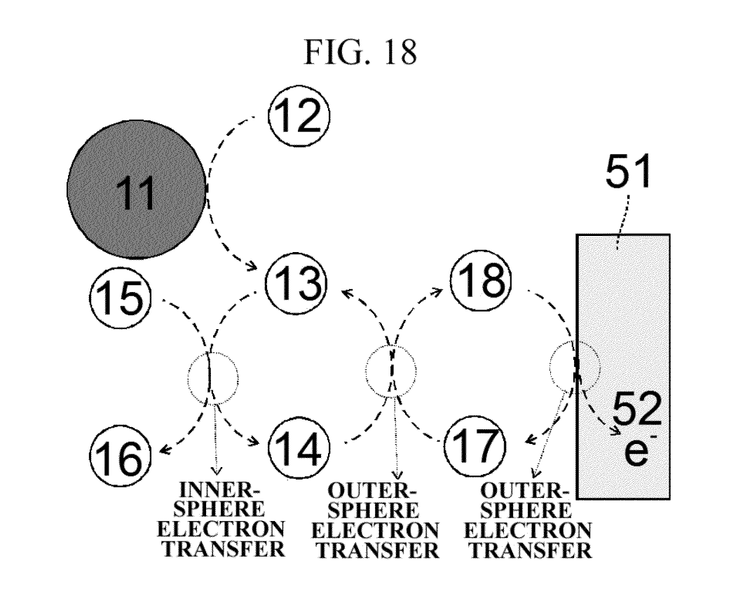

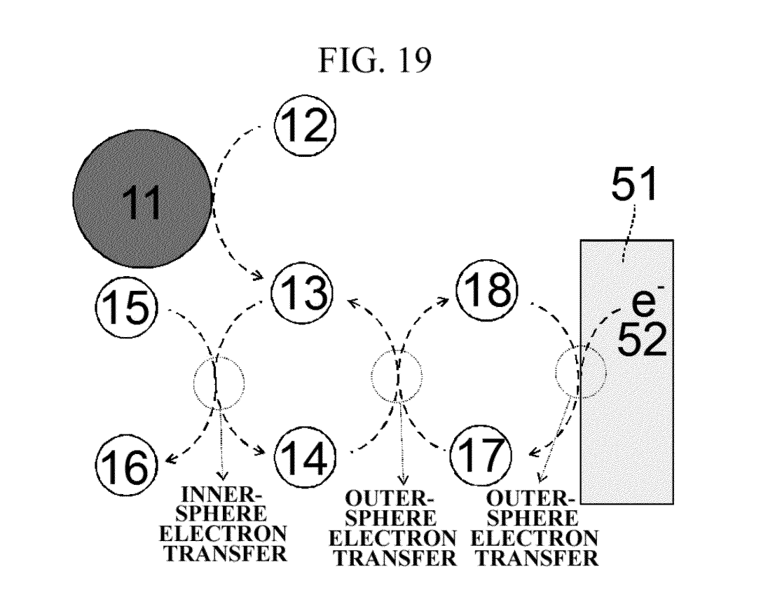

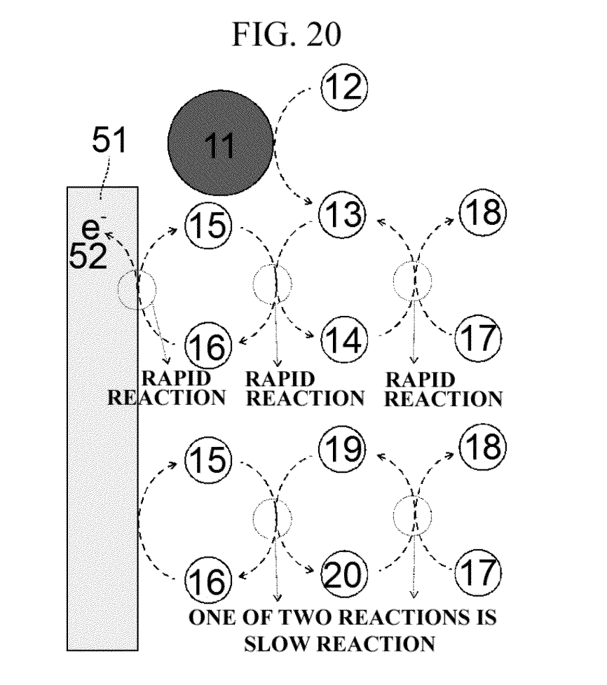

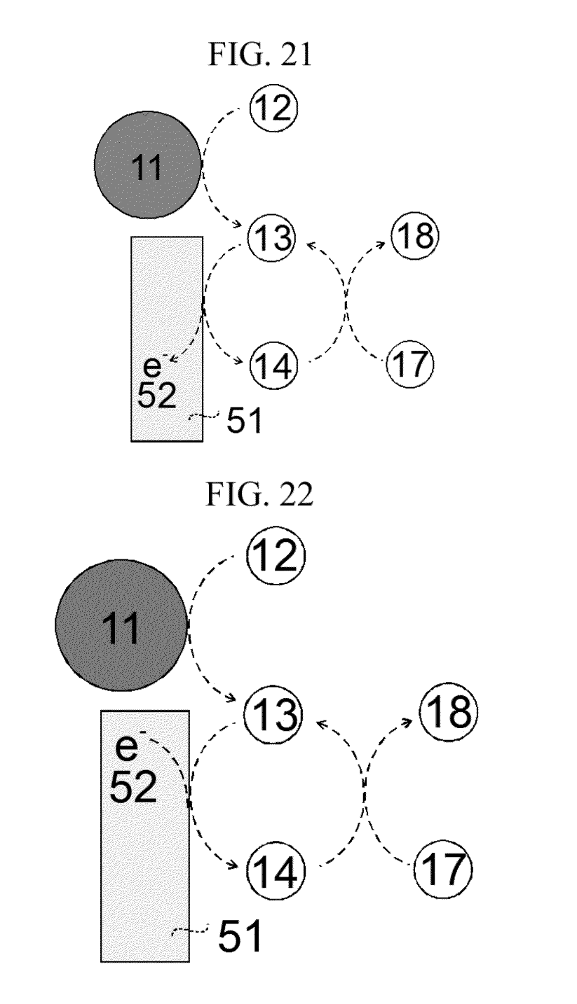

### DETAILED DESCRIPTION

Hereinafter, exemplary embodiments will be described with reference to accompanying drawings.

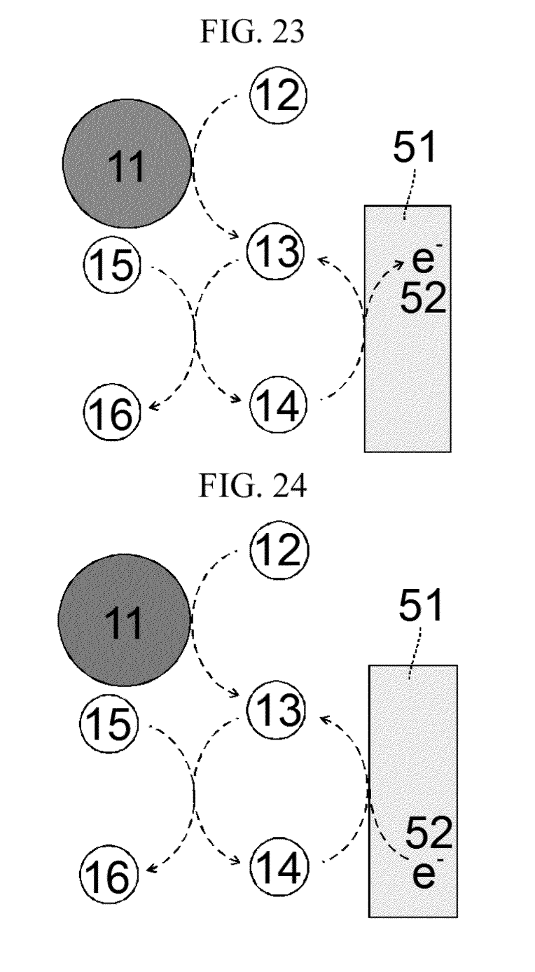

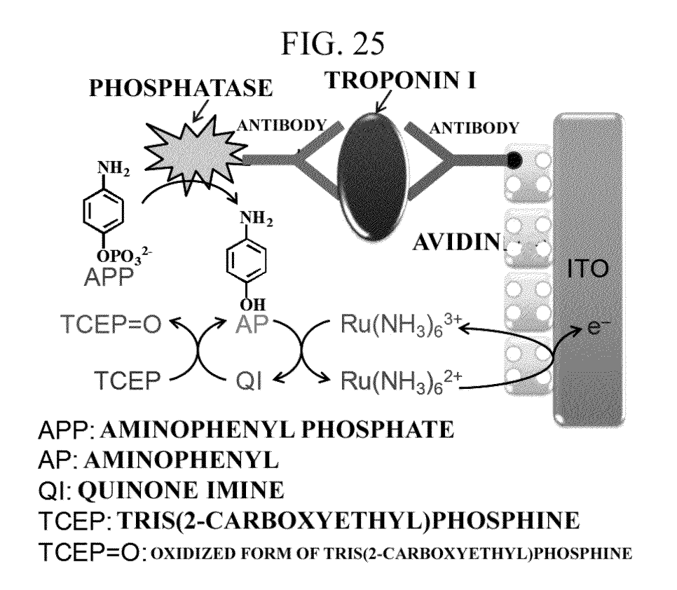

FIG. 25 is an example of a biosensor which is presented by the present invention. FIG. 25 illustrates a concept view of an electrochemical biosensor in a sandwich form, which detects troponin I. Avidin is applied on an ITO electrode, and an antibody in which troponin I may be captured by a biotin-avidin bond is immobilized thereon. After troponin I to be measured is captured on the surface, an antibody with which phosphatase is conjugated is bound to troponin I. When the electrode is immersed in a solution containing aminophenyl phosphate, aminophenyl phosphate is converted into aminophenol by phosphatase. When the enzyme reaction occurs for a certain period of time, aminophenol is produced in a large amount. When aminophenol is produced, redox cycling occurs by means of Ru(NH₃)₆³⁺ and tris(2-carboxyethyl)phosphine, so that Ru(NH₃)₆³⁺ is produced in a large amount. When Ru(NH₃)₆³⁺ is oxidized in an ITO electrode after a certain period of time, a redox cycling (from an outer-sphere electron transfer to an inner-sphere electron transfer) proceeds while Ru(NH₃)₆³⁺ is produced. Through this, a large electrochemical signal is obtained.

The biosensor of FIG. 25 is manufactured by the following procedure. After an ITO electrode with a size of 1 cm×2 cm is washed, 70 mL of a carbonate buffer (pH 9.6) solution containing 100 μg/mL of avidin is dropped onto the ITO electrode, and then the electrode is maintained at 20° C. for 2 hours and washed. 70 mL of a PBSB (phosphate-buffered saline with bovine serum albumin) solution is again dropped onto the electrode, and then the electrode is maintained at 4° C. for 30 minutes and washed. In order to immobilize the troponin I antibody by the biotin-avidin bond, 70 mL of a TBS (tris-buffered saline) solution containing 10 μg/mL of “biotinylated anti-troponin-I IgG” is dropped onto the electrode, and then the electrode is maintained at 4° C. for 30 minutes and washed. Subsequently, 70 mL of human serum containing troponin I at different concentrations is dropped onto the electrode, and then the electrode is maintained at 4° C. for 30 minutes and washed. Finally, 70 mL of a TBS solution containing 10 μg/mL of “alkaline phosphatase-conjugated anti-troponin-I IgG” is dropped onto the electrode, and then the electrode is maintained at 4° C. for 30 minutes and washed. In order to obtain an electrochemical signal, an electrochemical signal is measured by using Ag/AgCl (3M NaCl) as a reference electrode, platinum as a counter electrode, and an ITO electrode as a working electrode in an electrochemical cell made of Teflon. The size of the ITO electrode exposed to the solution is 0.28 cm². A tris buffer (pH 8.9) solution containing 1 mM of aminophenyl phosphate, 1 mM of Ru(NH₃)₆³⁺, and 2 mM of tris(2-carboxyethyl)phosphine is put into the electrochemical cell, amplification by means of alkaline phosphatase and amplification by means of chemical-chemical redox cycling are allowed to occur at 30° C. for 10 minutes, and then an electrochemical signal by means of electrochemical-chemical-chemical redox cycling is measured.

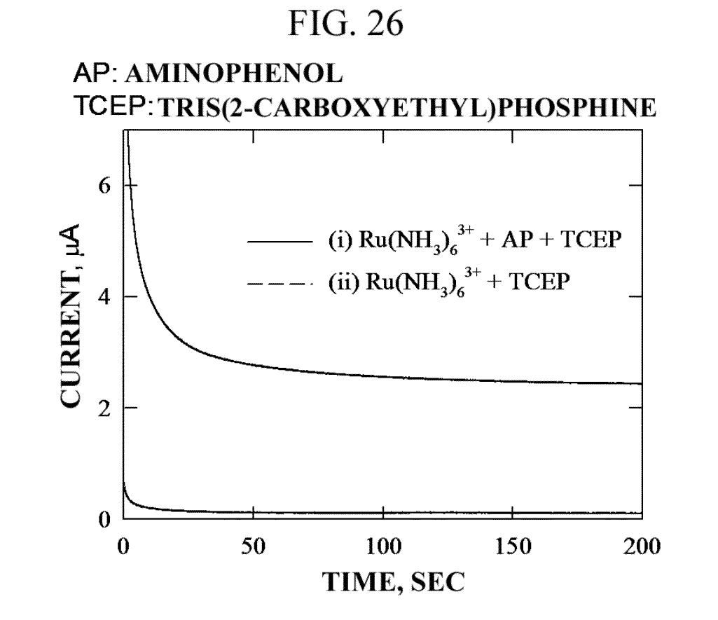

FIG. 26 illustrates a chronoamperogram obtained at an electric potential, in which oxidation of Ru(NH₃)₆²⁺ occurs with or without aminophenol in a solution containing Ru(NH₃)₆³⁺ and tris(2-carboxyethyl)phosphine. A tris buffer solution (pH 8.9) containing 1 mM of Ru(NH₃)₆³⁺ and 2 mM of tris(2-carboxyethyl)phosphine, or a tris buffer solution (pH 8.9) containing 1 mM of Ru(NH₃)₆³⁺, 0.1 mM of aminophenol, and 2 mM of tris(2-carboxyethyl)phosphine is used. The chronoamperogram is obtained by an ITO electrode at 0.05 V compared to an Ag/AgCl reference electrode. It is shown that when aminophenol is present, current is significantly increased by means of redox cycling. Furthermore, it is shown that when aminophenol is present, the current maintains a steady state after being decreased in the initial period of time. This shows that redox cycling occurs continuously and stably.

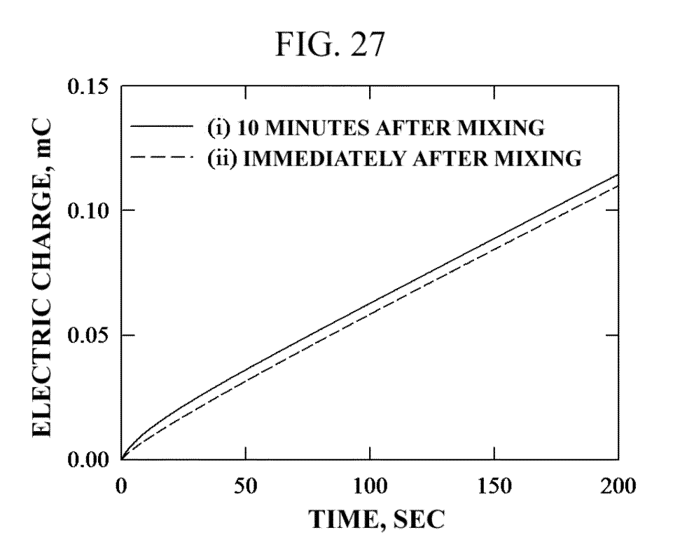

FIG. 27 is a chronocoulogram obtained immediately after and 10 minutes after a solution is mixed. A tris buffer solution (pH 8.9) containing 1 mM of Ru(NH₃)₆³⁺, 0.01 mM of aminophenol, and 2 mM of tris(2-carboxyethyl)phosphine is used, and the chronocoulogram is obtained by an ITO electrode at 0.05 V compared to the Ag/AgCl reference electrode. It is shown that an electric charge value of the chronocoulogram, which is obtained after the solution is mixed and left to stand for 10 minutes, is higher than an electric charge value of the chronocoulogram which is obtained immediately after the solution is mixed. This is because the chemical-chemical redox cycling as illustrated in FIG. 4 occurs by Ru(NH₃)₆³⁺, aminophenol, and tris(2-carboxyethyl)phosphine for 10 minutes after the solution is mixed. The difference in electric charge value between the two chronocoulograms increases in the initial period of time, and then continuously maintains a constant value. This means that the electrochemical-chemical-chemical redox cycling of FIG. 25 similarly occurs in both the cases. That is, it means that the effect of the chemical-chemical redox cycling is greatly exhibited in the initial period of time of the electrochemical measurement, whereas the effect of electrochemical-chemical-chemical redox cycling usually occurs when a certain period of time passes.

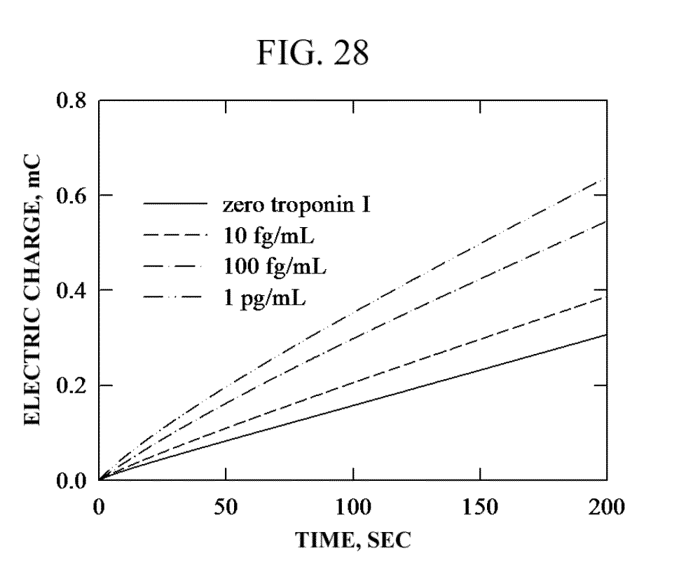

FIG. 28 is a chronocoulogram according to the concentration of troponin I, which is obtained by the biosensor of FIG. 25. A tris buffer solution (pH 8.9) containing 1 mM of Ru(NH₃)₆³⁺, 1 mM of aminophenyl phosphate, and 2 mM of tris(2-carboxyethyl)phosphine is used, and the chronocoulogram is obtained by an ITO electrode in which bio sensing occurs at 0.05 V compared to the Ag/AgCl reference electrode. The higher the concentration of troponin I is, the higher the electric charge value is shown at the same time.

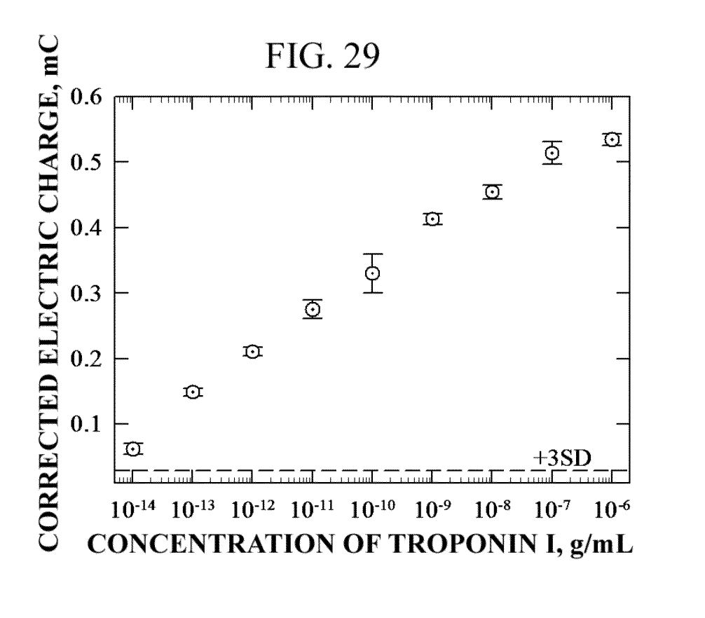

FIG. 29 illustrates a graph of a corrected electric charge according to the concentration of troponin I at 100 seconds in the chronocoulogram of FIG. 28. All the data are obtained by subtracting an average value obtained at the concentration of 0 from the original values, and all the concentration results are obtained by performing an experiment in triplicate. The error bar represents a standard deviation. The detection limit for troponin I calculated from the graph is 10 fg/mL. It is shown that a very low detection limit may be obtained by using triple amplification including new chemical-chemical redox cycling and electrochemical-chemical-chemical redox cycling.

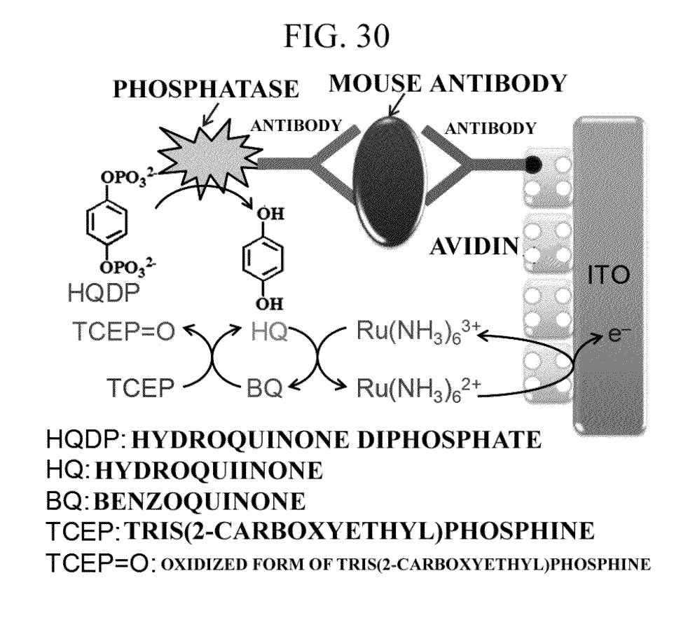

FIG. 30 is another example of a biosensor which is presented by the present invention. FIG. 30 illustrates a concept view of an electrochemical biosensor in a sandwich form, which detects a mouse antibody. In FIG. 30, the sensor is manufactured in the same manner as in the biosensor which is presented in FIG. 25, and measurement is made. However, the mouse antibody and hydroquinone diphosphate are used instead of troponin I and aminophenol phosphate in FIG. 25.

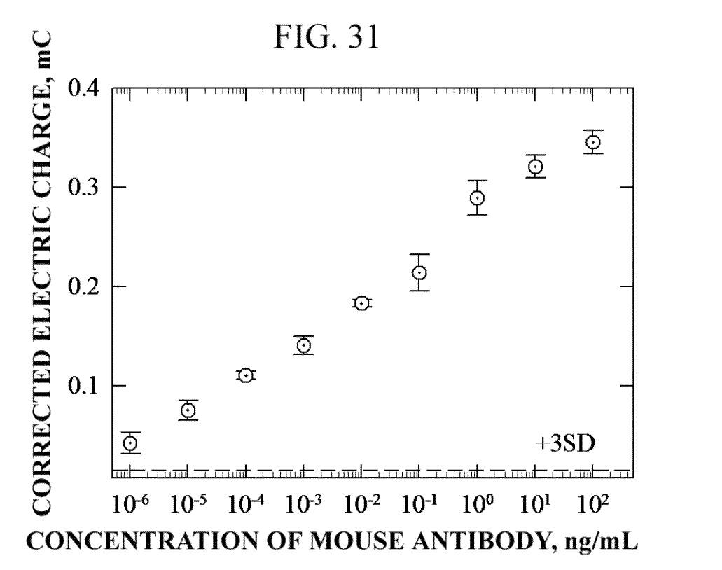

FIG. 31 illustrates a graph of a corrected electric charge according to the concentration of the mouse antibody obtained at 100 seconds in the chronocoulogram for the biosensor of FIG. 30. A tris buffer solution (pH 8.9) containing 1 mM of Ru(NH₃)₆³⁺, 1 mM of hydroquinone diphosphate, and 2 mM of tris(2-carboxyethyl)phosphine is used, and the chronocoulogram is obtained by an ITO electrode in which bio sensing occurs at 0.05 V compared to the Ag/AgCl reference electrode. All the data are obtained by subtracting an average value obtained at the concentration of 0 from the original values, and all the concentration results are obtained by performing an experiment in triplicate. The error bar represents a standard deviation. The detection limit for the mouse antibody calculated from the graph is 1 fg/mL. A very low detection limit may be obtained by using triple amplification including new chemical-chemical redox cycling and electrochemical-chemical-chemical redox cycling even in the biosensor using hydroquinone diphosphate.

Hydroquinone diphsphate has two phosphates, and thus an enzyme reaction needs to occur two times so as to become hydroquinone which is electrochemically active. However, hydroquinone diphosphate is rarely reacted with an oxidant or a reductant, and thus allows a low background signal to be obtained, and induces the redox by hydroquinone rapidly and stably, thereby allowing a large signal to be obtained.

FIG. 32 is another example of a biosensor which is presented by the present invention. FIG. 32 illustrates a concept view of an electrochemical biosensor in a sandwich form, which detects a mouse antibody. In FIG. 32, the sensor is manufactured in the same manner as in the biosensor which is presented in FIG. 25, and measurement is made. However, a mouse antibody, aminonaphthyl galactose, and “galatose-conjugated mouse antibody” are used instead of troponin I, aminophenol phosphate, and “alkaline phosphatase-conjugated anti-troponin-I IgG” in FIG. 25.

In the biosensors of FIGS. 25 and 30, the measurement of electrochemical signals is performed at pH of 8.9. The formal potential of Ru(NH₃)₆³⁺ does not depend on the pH, whereas the formal potential of aminophenol and hydroquinone depends on the pH. When the pH is decreased, the difference in formal potentials between Ru(NH₃)₆³⁺ and aminophenol (or hydroquinone) is increased, and electrochemical-chemical-chemical redox cycling is slowed down. Accordingly, the electrochemical-chemical-chemical redox cycling for aminophenol (or hydroquinone) is slowed down even more at pH of 7.4 so that large signal amplification may not be obtained. On the contrary, since aminonaphthol has a formal potential much lower than that of aminophenol and hydroquinone, a rapid electrochemical-chemical-chemical redox cycling may be obtained even at pH of 7.4.

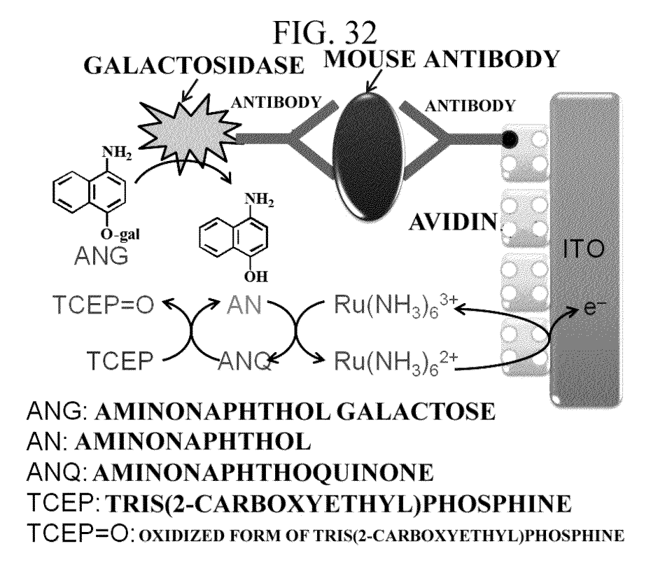

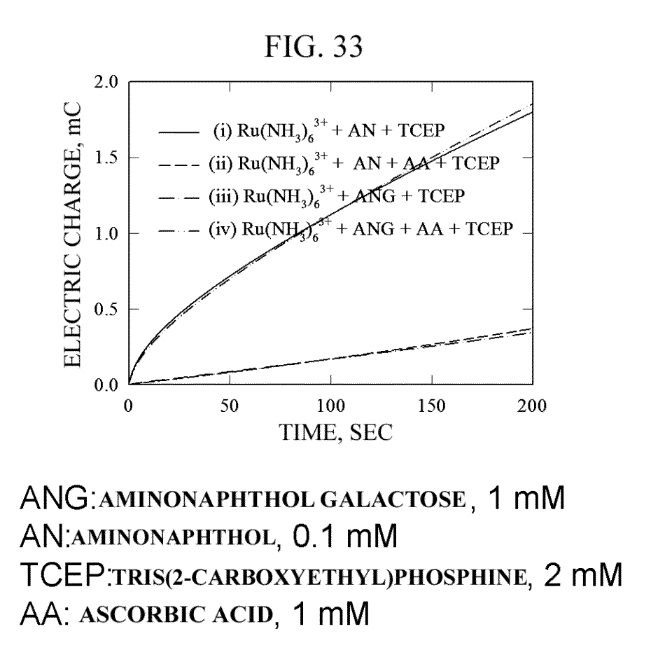

FIG. 33 illustrates a change in background electric charge and signal electric charge with or without ascorbic acid which is an interferent in whole blood or serum. When ascorbic acid is present, a significant increase in background electric charge and signal electric charge does not occur. This is because ascorbic acid induces an electrochemical reaction to occur slowly at 0.05 V in an ITO electrode which is poor in electrode catalytic properties, and the electrochemical-chemical-chemical redox cycling of ascorbic acid slowly occurs. On the contrary, since the electrochemical-chemical-chemical redox cycling of aminonaphthol rapidly occurs, a signal electric charge may be measured while minimizing the interfering action of ascorbic acid.

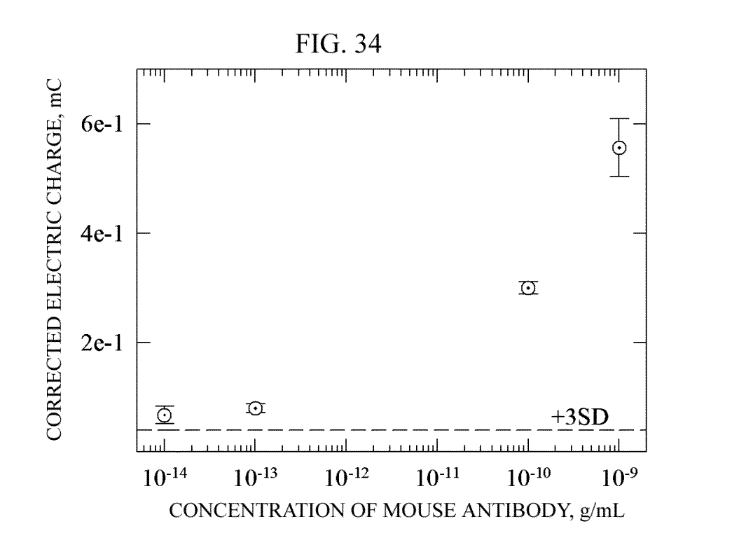

FIG. 34 illustrates a graph of a corrected electric charge according to the concentration of the mouse antibody obtained at 100 seconds in the chronocoulogram for the biosensor of FIG. 32. A PBS (phosphate-buffered saline) buffer solution (pH 7.4) containing 1 mM of Ru(NH₃)₆³⁺, 1 mM of hydroquinone diphosphate, and 2 mM of tris(2-carboxyethyl)phosphine is used, and the chronocoulogram is obtained by an ITO electrode in which bio sensing occurs at 0.05 V compared to the Ag/AgCl reference electrode. All the data are obtained by subtracting an average value obtained at the concentration of 0 from the original values, and all the concentration results are obtained by performing an experiment in triplicate. The error bar represents a standard deviation. The detection limit for the mouse antibody calculated from the graph is 100 fg/mL. A very low detection limit may be obtained by using triple amplification including new chemical-chemical redox cycling and electrochemical-chemical-chemical redox cycling even in the biosensor using aminonaphthyl galactose at pH of 7.4.

When the product of the enzyme reaction is aminophenol or hydroquinone, a low detection limit may not be obtained due to a slow redox cycling at pH of 7.4, but when the product is aminonaphthol, which has a formal potential lower than that of aminophenol and hydroquinone, a low detection limit may be obtained due to a rapid redox cycling.

Various substitutions, modifications, and changes can be made within the scope without departing from the spirit of the present invention by those skilled in the art, and as a result, the present invention as describe above is not limited to the aforementioned embodiments and the accompanying drawings.

What is claimed is:

1. A biosensor which measures a presence and concentration of a biomolecule, the biosensor comprising:
an enzyme which activates a substrate;
a substrate which is activated by the enzyme and becomes a product to be subjected to a redox reaction; and
a reductant and an oxidant which achieve the redox cycling by means of the redox reaction of the product,
wherein a direct redox reaction between the oxidant and the reductant kinetically rarely occurs, an electron transfer occurs between the product and the oxidant or the reductant, and a redox reaction and a redox cycling of the oxidant and the reductant are achieved by mediation of the product, and
a signal is sensed from an electrochemical, color, or fluorescent change of an oxidation product of the reductant or a reduction product of the oxidant, which is amplified and produced by means of repetition of the redox cycling.

2. The biosensor of claim 1, wherein the enzyme is an enzyme which is not greatly affected by the oxidant and the reductant.

3. The biosensor of claim 1, wherein the product is selected from the group consisting of hydroquinone, aminophenol, derivatives having a benzene ring comprising diaminobenzene, dihydroxynaphthalene, aminonaphthol, derivatives having a naphthalene ring comprising diaminonaphthalene, benzoquinone, quinone imine, naphthoquinone, naphthoquinone imine, and derivatives thereof.

4. The biosensor of claim 1, wherein the reductant is selected from the group consisting of hydrazine and derivatives thereof, a phosphine derivative comprising tris(2-carboxyethyl)phosphine, and a reduced form of a nicotinamide derivative comprising a reduced form of nicotinamide adenine dinucleotide.

5. The biosensor of claim 1, wherein the oxidant is selected from the group consisting of Ru(NH₃)₆³⁺, Ru(NH₃)₅(pyridine)³⁺ and derivatives thereof, Ru(NH₃)₄(diimine)³⁺ derivatives comprising Ru(NH₃)₄(bipyridyl)³⁺, ferrocenium ion and derivatives thereof, and Fe(CN)₆³⁻.

6. The biosensor of claim 1, further comprising:
an electrode which induces an electrochemical reaction such that a reduction product of the oxidant or an oxidation product of the reductant is electrochemically oxidized or reduced to become an oxidant or a reductant.

7. The biosensor of claim 2, wherein the enzyme is phosphatase, galatosidase, or a protease.

8. The biosensor of claim 6, wherein a signal is amplified by repeating a process in which the oxidant or the reductant produced by an electrochemical reaction in the electrode is reduced or oxidized by the redox cycling to produce a reduction product of the oxidant or an oxidation product of the reductant, and again becomes the oxidant or the reductant by an electrochemical reaction of the reduction product of the oxidant or the oxidation product of the reductant.

9. The biosensor of claim 6, wherein the electrode electrochemically rarely reduces or oxidizes the oxidant or the reductant.

10. The biosensor of claim 8, wherein the electrode electrochemically reduces or oxidizes the product or an oxidation product or a reduction product of the product produced by the redox cycling, and a signal is amplified by the electrochemical reaction.

11. The biosensor of claim 7, wherein the substrate of the enzyme is selected from the group consisting of aminophenyl phosphate, hydroquinone phosphate, hydroquinone diphosphate, aminonaphthyl phosphate, naphthohydroquinone phosphate, naphthohydroquinone diphosphate, aminophenyl galactose, hydroquinone galactose, hydroquinone digalactose, aminonaphthyl galactose, naphthohydroquinone galactose, naphthohydroquinone digalactose, aminophenyl oligopeptide, aminonaphthyl oligopeptide, and diaminonaphthalene dioligopeptide.

12. The biosensor of claim 9, wherein the electrode is a tin oxide electrode comprising an ITO electrode and an FTO (fluorinated tin oxide) electrode, a boron-doped diamond electrode, or a diamond-like carbon electrode.

13. The biosensor of claim 12, wherein an electron transfer slowly occurs between the oxidant or the reductant and an interferent, so that a redox cycling in which the oxidant, the reductant, and the interferent participate occurs slowly.
